(19) United States
(12) Patent Application Publication
(10) Pub. No.: US 2025/0162315 A1
(43) Pub. Date: May 22, 2025

(54) INKJET PRINTING HEAD

(71) Applicant: Samsung Display Co., Ltd., Yongin-si (KR)

(72) Inventors: Seora Kim, Yongin-si (KR); Donghoon Lee, Yongin-si (KR); Gyutae Kim, Yongin-si (KR); Sukbeom You, Yongin-si (KR)

(73) Assignee: Samsung Display Co., Ltd., Yongin-si (KR)

(21) Appl. No.: 18/949,036

(22) Filed: Nov. 15, 2024

(30) Foreign Application Priority Data
Nov. 16, 2023 (KR) 10-2023-0159284

(51) Int. Cl. B41J 2/085; B41J 2/06; B41J 2/10; B41J 2/14

(52) U.S. Cl. CPC B41J 2/085; B41J 2/06; B41J 2/10; B41J 2/1433

(57) ABSTRACT

An inkjet printing head includes a chamber storing ink, a nozzle plate disposed under the chamber, connected to an inside of the chamber, and including a plurality of nozzles that discharge the ink to outside through a bottom surface of the chamber, a plurality of driving electrodes each disposed to be adjacent to the plurality of nozzles, respectively, inside the nozzle plate, and a plurality of shielding electrodes disposed inside the nozzle plate, wherein each of the plurality of shielding electrodes is disposed between the plurality of nozzles.

### CROSS-REFERENCE TO RELATED APPLICATION

This application claims priority to and benefits of Korean Patent Application No. 10-2023-0159284 under 35 U.S.C. § 119, filed on Nov. 16, 2023, in the Korean Intellectual Property Office (KIPO), the disclosure of which is incorporated by reference herein in its entirety.

### BACKGROUND

### 1. Technical Field

One or more embodiments relate to an inkjet printing head, and more particularly, to an inkjet printing head configured to prevent a nozzle from malfunctioning due to an electromagnetic field occurring between driving electrodes.

### 2. Description of the Related Art

Generally, an inkjet printing head 100 is an apparatus configured to print images with a preset color on the surface of a printing medium by discharging fine droplets at desired positions on the printing medium. The scope of applications of inkjet printing heads is expanding to various fields such as flat display fields such as liquid crystal displays (LCD) and organic light-emitting devices (OLED), flexible display fields such as electronic paper, printed electronics fields such as metal wiring, and bio fields.

Drop-on-demand (DOD) type inkjet printing heads are classified into piezoelectric inkjet printing heads that discharge ink using pressure waves caused by the deformation of the piezoelectric material, and inductive electrohydrodynamic inkjet printing head that discharges inks using an electrostatic force depending on a discharge method.

An inductive electrohydrodynamic inkjet printing head may include driving electrodes configured to transfer a driving voltage. However, in the case of a fine printing process, an inkjet printing head may malfunction due to an electric field interference occurring between driving electrodes.

### SUMMARY

One or more embodiments include an inkjet printing head configured to prevent a nozzle from malfunctioning due to an electromagnetic field occurring between driving electrodes. However, such a technical objective is an example, and the disclosure is not limited thereto.

Additional aspects will be set forth in part in the description which follows and, in part, will be apparent from the description, or may be learned by practice of the presented embodiments of the disclosure.

According to one or more embodiments, an inkjet printing head includes a chamber storing ink, a nozzle plate disposed under the chamber, connected to an inside of the chamber, and including a plurality of nozzles that discharge the ink to outside through a bottom surface of the chamber, a plurality of driving electrodes each disposed to be adjacent to the plurality of nozzles, respectively, inside the nozzle plate, and a plurality of shielding electrodes disposed inside the nozzle plate, wherein each of the plurality of shielding electrodes is disposed between the plurality of nozzles.

The plurality of shielding electrodes may be grounded.

The plurality of driving electrodes may be in direct contact with the ink.

The inkjet printing head may further include a voltage supply portion that applies a voltage to the plurality of driving electrodes.

The plurality of driving electrodes may be disposed along an inner lateral surface of the plurality of nozzles.

The plurality of shielding electrodes may be arranged between the plurality of driving electrodes.

An upper surface of each of the plurality of shielding electrodes may be apart from an upper surface of the nozzle plate by a first length.

The nozzle plate may include a lower plate including a plurality of nozzle heads that discharge the ink to outside through a bottom surface of the chamber, and an upper plate including an ink transfer passage that transfers the ink from the chamber to the plurality of nozzle heads.

A lower surface of each of the plurality of shielding electrodes may be in contact with an upper surface of the lower plate.

An upper surface of each of the plurality of shielding electrodes may be apart from an upper surface of the upper plate by a second length.

A height of each of the plurality of shielding electrodes may be substantially equal to a height of the nozzle plate.

Each of the plurality of shielding electrodes may be disposed between a lower surface of the nozzle plate and an upper surface of the nozzle plate.

According to one or more embodiments, an inkjet printing head includes a chamber storing ink, a nozzle plate disposed under the chamber, connected to an inside of the chamber, and including a plurality of nozzles that discharge the ink to outside through a bottom surface of the chamber, a plurality of driving electrodes each disposed to be adjacent to the plurality of nozzles, respectively, inside the nozzle plate, and a plurality of shielding electrodes disposed on an upper surface of the nozzle plate, wherein each of the plurality of shielding electrodes is disposed between the plurality of nozzles.

The plurality of shielding electrodes may be grounded.

The plurality of driving electrodes may be in direct contact with the ink.

The inkjet printing head may further include a voltage supply portion that applies a voltage to the plurality of driving electrodes.

The plurality of driving electrodes may be disposed along an inner lateral surface of the plurality of nozzles.

The plurality of shielding electrodes may be arranged between the plurality of driving electrodes.

The nozzle plate may include a lower plate including a plurality of nozzle heads that discharge the ink to outside through a bottom surface of the chamber, and an upper plate including an ink transfer passage that transfers the ink from the chamber to the plurality of nozzle heads.

The inkjet printing head may further include a plurality of partition walls disposed between the plurality of shielding electrodes and the nozzle plate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of an inkjet printing head according to an embodiment;

FIG. 2 is a schematic cross-sectional view of a first example of a region A of FIG. 1;

FIG. 3 is a schematic perspective view of the first example of a region A of FIG. 1;

FIG. 4 is a graph showing a voltage measured around a first nozzle head to a third nozzle head of the first example;

FIGS. 5 and 6 are graphs showing an electric field shielding effect according to a first length of the first example;

FIG. 7 is a schematic cross-sectional view of a second example of the region A of FIG. 1;

FIG. 8 is a schematic perspective view of the second example of the region A of FIG. 1;

FIG. 9 is a schematic cross-sectional view of a third example of the region A of FIG. 1;

FIG. 10 is a schematic perspective view of a third example of the region A of FIG. 1;

FIGS. 11 and 12 are graphs showing an electric field shielding effect according to a height to each of shielding electrodes;

FIG. 13 is a schematic cross-sectional view of a fourth example of the region A of FIG. 1;

FIG. 14 is a schematic perspective view of the fourth example of the region A of FIG. 1;

FIG. 15 is a schematic cross-sectional view of a fifth example of the region A of FIG. 1;

FIG. 16 is a schematic perspective view of a fifth example of the region A of FIG. 1;

FIG. 17 is a schematic cross-sectional view of a comparative example of the region A of FIG. 1; and

FIG. 18 is a graph showing a voltage measured around a first nozzle head to a third nozzle head of the comparative example.

### DETAILED DESCRIPTION OF THE EMBODIMENTS

Reference will now be made in detail to embodiments, examples of which are illustrated in the accompanying drawings, wherein like reference numerals and/or characters refer to like elements throughout. In this regard, the embodiments may have different forms and should not be construed as being limited to the descriptions set forth herein. Accordingly, the embodiments are merely described below, by referring to the figures, to explain aspects of the description.

As the disclosure allows for various changes and numerous embodiments, certain embodiments will be illustrated in the drawings and described in the written description. Effects and features of the disclosure, and methods for achieving them will be clarified with reference to embodiments described below in detail with reference to the drawings. However, the disclosure is not limited to the following embodiments and may be embodied in various forms.

Hereinafter, embodiments will be described with reference to the accompanying drawings, wherein like reference numerals refer to like elements throughout and a repeated description thereof is omitted.

While such terms as “first” and “second” may be used to describe various elements, such elements must not be limited to the above terms. The above terms are used to distinguish one element from another. In addition, the singular forms, such as “a” and “an,” as used herein are intended to include the plural forms as well unless the context clearly indicates otherwise.

As used herein, when various elements such as a layer, a region, a plate, and the like are disposed “on” another element, not only the elements may be disposed “directly on” the other element, but another element may be disposed therebetween.

In addition, sizes of elements in the drawings may be exaggerated or reduced for convenience of explanation. As an example, the size and thickness of each element shown in the drawings are arbitrarily represented for convenience of description, and thus, the disclosure is not necessarily limited thereto.

It will be understood that the terms “comprise,” “comprising,” “include” and/or “including” as used herein specify the presence of stated features or elements but do not preclude the addition of one or more other features or elements.

It will be further understood that, when a layer, region, or element is referred to as being “on” another layer, region, or element, it can be directly or indirectly on the other layer, region, or element. That is, for example, intervening layers, regions, or elements may or may not be present.

In the case where a certain embodiment may be implemented differently, a specific process order may be performed in the order different from the described order. As an example, two processes successively described may be simultaneously performed substantially and performed in the opposite order.

The term “and/or” includes all combinations of one or more of which associated configurations may define. For example, “A and/or B” may be understood to mean “A, B, or A and B.”

For the purposes of this disclosure, the phrase “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z.

It will be understood that when a layer, region, or element is referred to as being “connected” to another layer, region, or element, it may be “directly connected” to the other layer, region, or element or may be “indirectly connected” to the other layer, region, or element with another layer, region, or element located therebetween. For example, it will be understood that when a layer, region, or element is referred to as being “electrically connected” to another layer, region, or element, it may be “directly electrically connected” to the other layer, region, or element or may be “indirectly electrically connected” to the other layer, region, or element with another layer, region, or element interposed therebetween.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different orientations that are not perpendicular to one another.

The term “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

Hereinafter, an inkjet printing head according to an embodiment is described in detail.

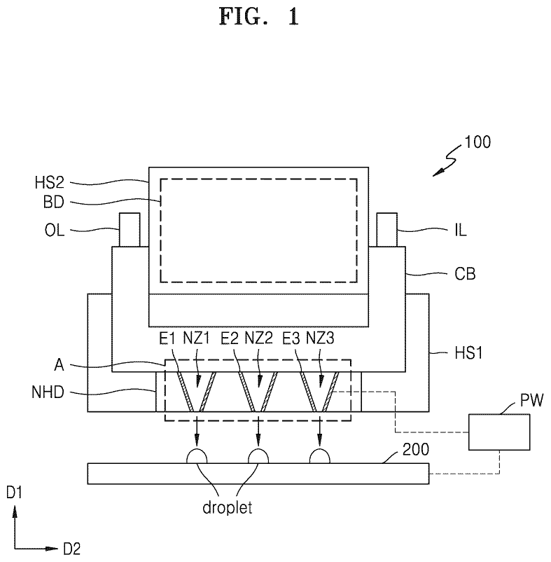

FIG. 1 is a schematic cross-sectional view of an inkjet printing head 100 according to an embodiment.

As shown in FIG. 1, the inkjet printing head 100 according to an embodiment may include a chamber CB storing inkjet printing ink and a nozzle plate NHD configured to discharge ink to the outside from the chamber CB. The chamber CB and the nozzle plate NHD may be included in a first housing HS1 of the inkjet printing head 100. The first housing HS1 may have a structure connected to a second housing HS2, and a driving circuit BD may be included in the second housing HS2.

Ink from the inkjet printing head 100 may be injected into the chamber CB through an ink injection portion (not shown), and move out to the outside through an ink discharge portion OL. As described above, the ink may mainly move from an ink injection portion IL to the chamber CB and to the ink discharge portion OL. The ink injection portion IL may communicate with the chamber CB to pass through the first housing HS1 and inject ink to the chamber CB, and the ink discharge portion OL may communicate with the chamber CB to pass through the first housing HS1 and discharge the ink from the chamber CB. The ink injection portion IL and the ink discharge portion OL may be opened or closed when needed and may be controlled manually or automatically.

The nozzle plate NHD may be configured to discharge ink to the outside through the bottom surface. The nozzle plate NHD is disposed under the chamber CB and may include nozzle portions. The nozzle portions are connected to the inside of the chamber CB and may be configured to discharge ink to the outside of the inkjet printing head 100 through the bottom surface of the nozzle plate NHD.

The nozzle portions may include at least a first nozzle portion NZ1 to a third nozzle portion NZ3. The nozzle portions may be configured to discharge ink to the outside through the bottom surface, wherein the ink may be transferred from the chamber CB. Although FIG. 1 shows only the first nozzle portion NZ1 to the third nozzle portion NZ3, for convenience of description and illustration, the inkjet printing head 100 may further include other nozzle portions. The nozzle portions may have a bottle neck structure. Accordingly, ink discharged to the outside of the inkjet printing head 100 through the nozzle portions may reach a higher hydraulic pressure while passing through the bottle neck structure.

Driving electrodes may be disposed along the inner lateral surface of the nozzle portion. Each of the driving electrodes may be disposed to be adjacent to the nozzle portions inside the nozzle plate NHD.

As an example, a first driving electrode E1 may be disposed along the inner lateral surface of the first nozzle portion NZ1. The first driving electrode E1 may be in direct contact with ink moving through the first nozzle portion NZ1. This is because the inkjet printing head 100 of an inductive electrohydrodynamic type needs to directly apply a voltage to the driving electrode.

As an example, a second driving electrode E2 may be disposed along the inner lateral surface of the second nozzle portion NZ2. The second driving electrode E2 may be in direct contact with ink moving through the second nozzle portion NZ2. As an example, a third driving electrode E3 may be disposed along the inner lateral surface of the third nozzle portion NZ3. The third driving electrode E3 may be in direct contact with ink moving through the third nozzle portion NZ3. Other driving electrodes may be disposed along the inner lateral surfaces of other nozzle portions.

A substrate 200 may be disposed below the nozzle plate NHD. The inkjet printing head 100 may be configured to discharge ink droplet on the substrate 200. The inkjet printing head 100 may be configured to perform a printing process by discharging ink on the substrate 200.

The inkjet printing head 100 may further include a voltage supply portion PW. The voltage supply portion PW may be configured to apply a voltage to the driving electrodes. As an example, the voltage supply portion PW may be configured to apply a first voltage to the driving electrodes and apply a second voltage to the substrate 200. The voltage supply portion PW may be configured to apply a voltage difference between the first voltage and the second voltage to the inkjet printing head 100 and the substrate 200. Ink may be discharged to the outside through the bottom surface of the nozzle plate NHD by an electric field due to a voltage applied from the voltage supply portion PW. As another example, ink may have a pointed shape due to an electric field caused by a voltage applied from the voltage supply portion PW, and as a result, a more precise printing process may be performed.

The inkjet printing head 100 may further include shielding electrodes, and the shielding electrodes are described below in detail. For convenience of illustration, although the shielding electrodes are omitted in FIG. 1, these are omitted for convenience of description. According to other drawings described below, the inkjet printing head 100 of FIG. 1 also includes the shielding electrodes.

A region A of FIG. 1 may denote a portion of a cross-section of the inkjet printing head 100, and the region A may include the nozzle plate NHD, the nozzle portions, and the driving electrodes. Furthermore, although not shown in FIG. 1, the region A may include the shielding electrodes.

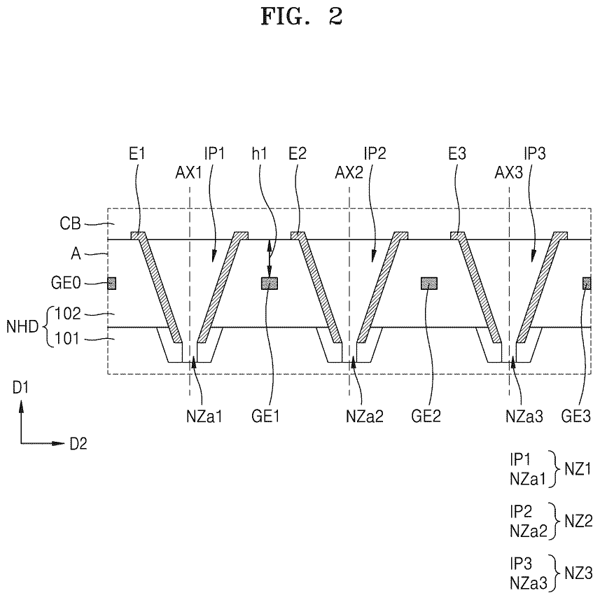

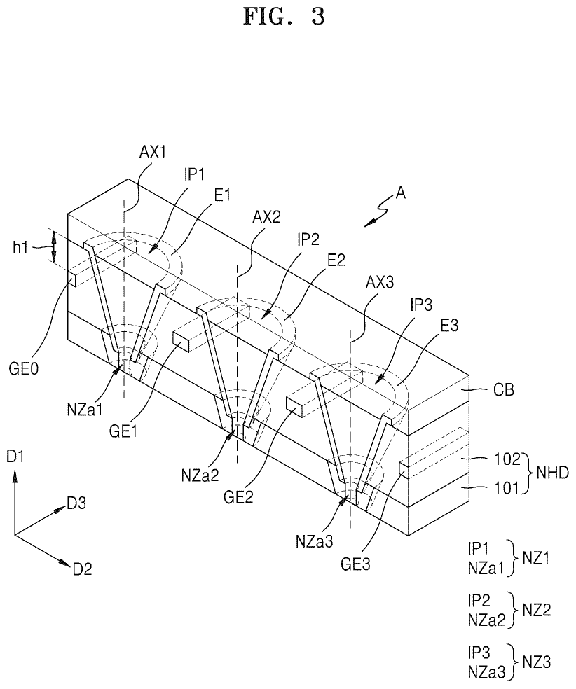

FIG. 2 is a schematic cross-sectional view of a first example of the region A of FIG. 1, and FIG. 3 is a schematic perspective view of the first example of the region A of FIG. 1.

For reference, in the description of FIG. 2, contents substantially identical or similar to or repeating those described above may be omitted.

As shown in FIGS. 2 and 3, the nozzle plate NHD may include a lower plate 101 including nozzle heads configured to discharge ink to outside through a bottom surface thereof, and an upper plate 102 including an ink transfer passage configured to transfer the ink from the chamber to the nozzle heads.

Each of the nozzle portions may include the ink transfer passage and the nozzle head, wherein the ink transfer passage is configured to receive ink from the chamber and is included in the upper plate 102, and the nozzle head is configured to discharge ink transferred from the ink transfer passage to the outside and is included in the lower plate 101. In this case, the driving electrodes may be disposed along the inner lateral surface of the ink transfer passage.

As an example, the first nozzle portion NZ1 may include a first ink transfer passage IP1 included in the upper plate 102, and a first nozzle head NZa1 included in the lower plate 101. The inner lateral surface of the first ink transfer passage IP1 and the inner lateral surface of the first nozzle head NZa1 form a continuous surface, and the inner sides of the first ink transfer passage IP1 and the first nozzle head NZa1 may be connected to each other.

Accordingly, ink may be transferred from the chamber to the first nozzle head NZa1 through the first ink transfer passage IP1, and may be discharged from the first nozzle head NZa1 to the outside of the nozzle plate NHD through the bottom surface of the nozzle plate NHD. The first driving electrode E1 may be disposed along the inner lateral surface of the first ink transfer passage IP1.

As an example, the second nozzle portion NZ2 may include a second ink transfer passage IP2 included in the upper plate 102, and a second nozzle head NZa2 included in the lower plate 101. The inner lateral surface of the second ink transfer passage IP2 and the inner lateral surface of the second nozzle head NZa2 form a continuous surface, and the inner sides of the second ink transfer passage IP2 and the second nozzle head NZa2 may be connected to each other. Accordingly, ink may be transferred from the chamber CB to the second nozzle head NZa2 through the second ink transfer passage IP2, and may be discharged from the second nozzle head NZa2 to the outside of the nozzle plate NHD through the bottom surface of the nozzle plate NHD. The second driving electrode E2 may be disposed along the inner lateral surface of the second ink transfer passage IP2.

As an example, the third nozzle portion NZ3 may include a third ink transfer passage IP3 included in the upper plate 102, and a third nozzle head NZa3 included in the lower plate 101. The inner lateral surface of the third ink transfer passage IP3 and the inner lateral surface of the third nozzle head NZa3 form a continuous surface, and the inner sides of the third ink transfer passage IP3 and the third nozzle head NZa3 may be connected to each other. Accordingly, ink may be transferred from the chamber CB to the third nozzle head NZa3 through the third ink transfer passage IP3, and may be discharged from the third nozzle head NZa3 to the outside of the nozzle plate NHD through the bottom surface of the nozzle plate NHD. The third driving electrode E3 may be disposed along the inner lateral surface of the third ink transfer passage IP3.

A first axis AX1 may be a virtual axis extending in a first direction D1 (e.g., direction perpendicular to the bottom surface of the nozzle plate NHD) passing through the center of the first nozzle portion NZ1. A second axis AX2 may be a virtual axis extending in the first direction D1 (e.g., direction perpendicular to the bottom surface of the nozzle plate NHD) passing through the center of the second nozzle portion NZ2. A third axis AX3 may be a virtual axis extending in the first direction D1 (e.g., direction perpendicular to the bottom surface of the nozzle plate NHD) passing through the center of the third nozzle portion NZ3.

The shielding electrodes may include at least a first shielding electrode GE1, a second shielding electrode GE2, and a third shielding electrode GE3. The shielding electrodes may include an additional shielding electrode GE0. As an example, the shielding electrodes may include a ground electrode. The shielding electrodes may be grounded. As an example, each of the shielding electrodes may be apart by a first length h1 from the upper surface of the nozzle plate NHD.

As shown in FIGS. 2 and 3, the first shielding electrode GE1 may be arranged between the first nozzle portion NZ1 and the second nozzle portion NZ2. The first shielding electrode GE1 may be included inside the nozzle plate NHD or the upper plate 102. The first shielding electrode GE1 may be apart from the upper surface of the lower plate 101 or the upper surface of the upper plate 102. The first shielding electrode GE1 may be arranged between the first driving electrode E1 and the second driving electrode E2. The first shielding electrode GE1 may be arranged between the first axis AX1 and the second axis AX2.

The second shielding electrode GE2 may be arranged between the second nozzle portion NZ2 and the third nozzle portion NZ3. The second shielding electrode GE2 may be included inside the nozzle plate NHD or the upper plate 102. The second shielding electrode GE2 may be apart from the upper surface of the lower plate 101 and the upper surface of the upper plate 102. The second shielding electrode GE2 may be arranged between the second driving electrode E2 and the third driving electrode E3. The second shielding electrode GE2 may be arranged between the second axis AX2 and the third axis AX3.

In addition to the first shielding electrode GE1 and the second shielding electrode GE2, the shielding electrodes may further include the additional shielding electrode GE0 according to the number of a nozzle portion. As an example, the shielding electrodes may further include the third shielding electrode GE3, and the third shielding electrode GE3 may be arranged between the third nozzle portion NZ3 and a fourth nozzle portion (not shown). Although the fourth nozzle portion (not shown) is not shown for convenience of illustration, the fourth nozzle portion may be arranged at a position apart in a second direction D2 (e.g., direction crossing the first direction D1) from the third nozzle portion NZ3.

As an example, the additional shielding electrode GE0 may be arranged around the first nozzle portion NZ1. Because description of the additional shielding electrode GE0 may be derived from the description of the other shielding electrodes, description thereof is omitted.

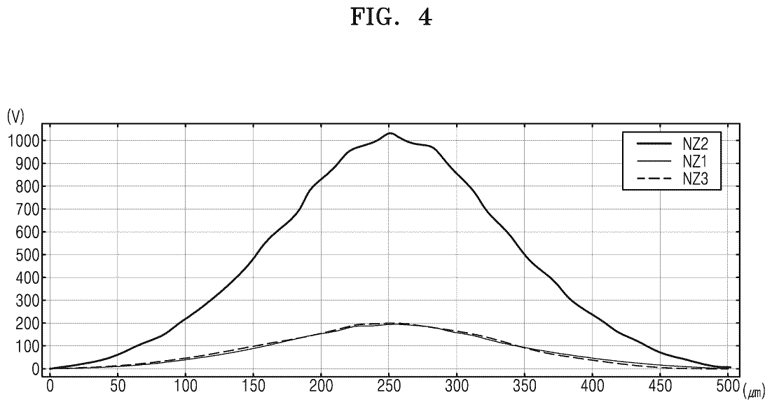

FIG. 4 is a graph showing a voltage measured around a first nozzle head to a third nozzle head NZa3 of the first example.

For reference, in the description of FIG. 4, contents substantially identical or similar to or repeating those described above may be omitted.

Referring to FIG. 4, the voltage around the first nozzle head NZa1 and the third nozzle head NZa3 is measured to be in a range of about 0 V to about 200 V or less. This is a measured value remarkably less than a voltage of about 1000 V or less, which is a voltage around the second nozzle head NZa2, and nearly does not influence inductive electrohydrodynamic driving of the first nozzle portion NZ1 and the third nozzle portion NZ3.

In the first example, voltages inside or around the first nozzle portion NZ1 to the third nozzle portion NZ3 are measured as follows.

TABLE 1

| | First nozzle portion | Second nozzle portion | Third nozzle portion |
|---|---|---|---|
| | (turned-off) | (turned-on) | (turned-off) |
| Measured | About 400 to about 700 | About 1000 to about | About 400 to about 700 |
| voltage (V) | | 1500 | |
| inside nozzle | | | |
| portion | | | |
| Around nozzle | About 0 to about 200 | About 0 to about 1000 | About 0 to about 200 |
| head | | | |
| Measured | | | |
| voltage (V) | | | |

(However, the measured value is not a voltage at a specific point but denotes a voltage distributed in a specific space and is expressed as a numerical range.)

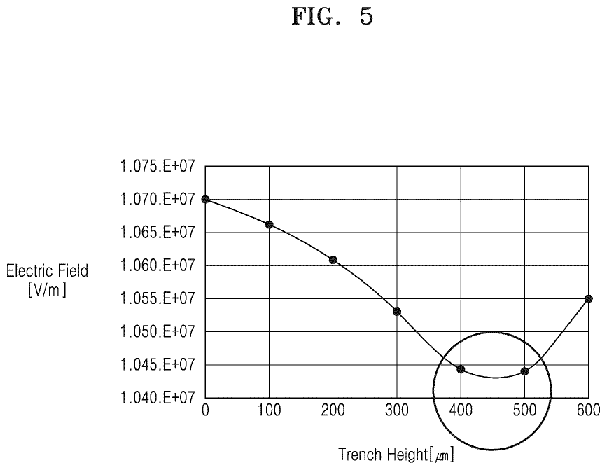

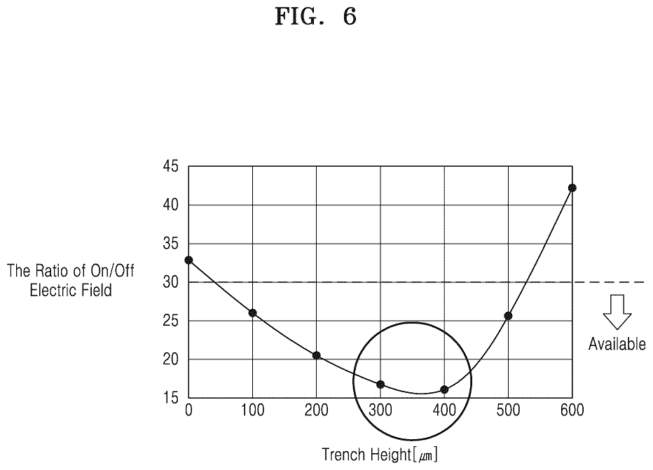

FIGS. 5 and 6 are graphs showing an electric field shielding effect according to a first length h1 of the first example.

For reference, in the description of FIGS. 5 and 6, contents substantially identical or similar to or repeating those described above may be omitted.

A trench height of an x axis in FIG. 5 may denote a distance such as the first length h1 between each of the shielding electrodes and the upper surface of the nozzle plate NHD. A y axis in FIG. 5 denotes an intensity of an electric field measured in a neighboring nozzle portion adjacent to a nozzle portion that is turned on, and specifically, may be an intensity of an electric field measured around a neighboring nozzle head adjacent to the nozzle portion that is turned on.

As shown in FIG. 5, in the case where a distance between each of the shielding electrodes and the upper surface of the nozzle plate NHD is in a range of about 400 μm to about 500 μm, it may be determined that a shielding effect due to the shielding electrode is a maximum.

As an example, in the case where a driving voltage is applied to the second driving electrode E2 of the first example, the first length h1 may be in a range of about 400 μm to about 500 μm. In the case where the first length h1 is in a range of about 400 μm to about 500 μm, an intensity of an electric field around the first nozzle head NZa1 and the third nozzle head NZa3 is minimized.

A trench height in an x axis in FIG. 6 may denote a distance such as the first length h1 between each of the shielding electrodes and the upper surface of the nozzle plate NHD. The y axis in FIG. 6 denotes a ratio of an intensity of an electric field measured in a neighboring nozzle portion adjacent to a nozzle portion that is turned on/off, and specifically, may be a ratio of an intensity of an electric field measured around a neighboring nozzle head adjacent to the nozzle portion that is turned on/off.

Generally, in the case where the ratio of the intensity of the above electric field is about 30 or less, it may be determined that the process is possible. Accordingly, referring to FIG. 6, the first length h1 may be in a range of about 100 μm to about 500 μm, and preferably, may be in a range of about 300 μm to about 400 μm.

Finally, the first length h1 meeting all of the preferable conditions of FIGS. 5 and 6 may be about 400 μm.

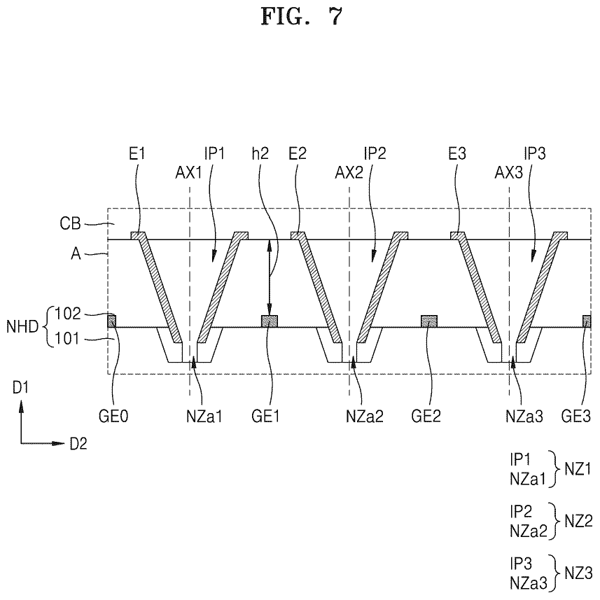

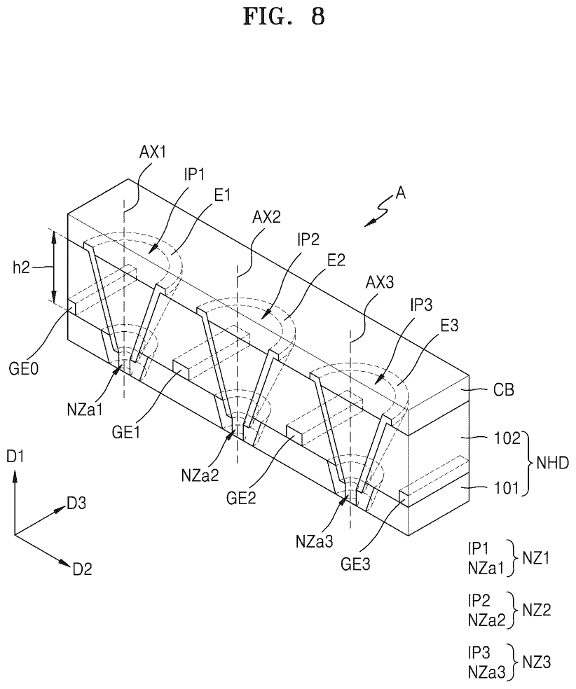

FIG. 7 is a schematic cross-sectional view of a second example of the region A of FIG. 1, and FIG. 8 is a schematic perspective view of the second example of the region A of FIG. 1.

For reference, in the description of FIGS. 7 and 8, contents substantially identical or similar to or repeating those described above may be omitted.

The shielding electrodes may include at least the first shielding electrode GE1, the second shielding electrode GE2, and the third shielding electrode GE3. The shielding electrodes may include the additional shielding electrode GE0. As an example, the shielding electrodes may be ground electrodes. The shielding electrodes may be grounded. As an example, each of the shielding electrodes may be apart by a second length h2 from the upper surface of the nozzle plate NHD. The second length h2 may be greater than the first length h1.

As shown in FIGS. 7 and 8, the first shielding electrode GE1 may be arranged between the first nozzle portion NZ1 and the second nozzle portion NZ2. The first shielding electrode GE1 may be included inside the nozzle plate NHD or the upper plate 102. The first shielding electrode GE1 may be in contact with the upper surface of the lower plate 101 and be apart from the upper surface of the upper plate 102. The first shielding electrode GE1 may be arranged between the first driving electrode E1 and the second driving electrode E2. The first shielding electrode GE1 may be arranged between the first axis AX1 and the second axis AX2.

The second shielding electrode GE2 may be arranged between the second nozzle portion NZ2 and the third nozzle portion NZ3. The second shielding electrode GE2 may be included inside the nozzle plate NHD or the upper plate 102. The second shielding electrode GE2 may be in contact with the upper surface of the lower plate 101 and be apart from the upper surface of the upper plate 102. The second shielding electrode GE2 may be arranged between the second driving electrode E2 and the third driving electrode E3. The second shielding electrode GE2 may be arranged between the second axis AX2 and the third axis AX3.

The shielding electrodes may further include the third shielding electrode GE3 and the additional shielding electrode GE0 in addition to the first shielding electrode GE1 and the second shielding electrode GE2. The third shielding electrode GE3 and the additional shielding electrode GE0 may also be in contact with the upper surface of the lower plate 101 and be apart from the upper surface of the upper plate 102.

In the second example, voltages inside or around the first nozzle portion NZ1 to the third nozzle portion NZ3 are measured as follows.

TABLE 2

| | First nozzle portion | Second nozzle portion | Third nozzle portion |
|---|---|---|---|
| | (turned-off) | (turned-on) | (turned-off) |
| Measured | About 600 to about | About 1100 to about | About 600 to about |
| voltage (V) | 1000 | 1500 | 1000 |
| inside nozzle | | | |
| portion | | | |
| Around nozzle | About 0 to about 800 | About 0 to about 1200 | About 0 to about 800 |
| head | | | |
| Measured | | | |
| voltage (V) | | | |

However, the measure value is not a voltage at a specific point but denotes a voltage distributed in a specific space and is expressed as a numerical range.)

According to Table 2, it may be determined that a magnetic field generated from the second driving electrode E2 has a low influence on the first nozzle portion NZ1 and the third nozzle portion NZ3 due to the first shielding electrode GE1 and the second shielding electrode GE2. The voltage of the inside of the first nozzle portion NZ1 and the third nozzle portion NZ3 is measured to be in a range of about 600 V to about 1000 V. This is a numerical value less than a voltage in a range of about 1100 V to about 1500 of the inside of the second nozzle portion NZ2.

The voltage around the first nozzle head NZa1 and the third nozzle head NZa3 is measured to be in a range of about 0 V to about 800 V. This is a measured value relatively less than a voltage of about 1200 V or less, which is a voltage around the second nozzle head NZa2, and does not influence inductive electrohydrodynamic driving of the first nozzle portion NZ1 and the third nozzle portion NZ3.

However, it may be determined that measured voltages shown in Table 2 are greater than measured voltages shown in Table 1. Accordingly, the position of the shielding electrode of the first example has a greater electric field shielding effect than the position of the shielding electrode of the second example.

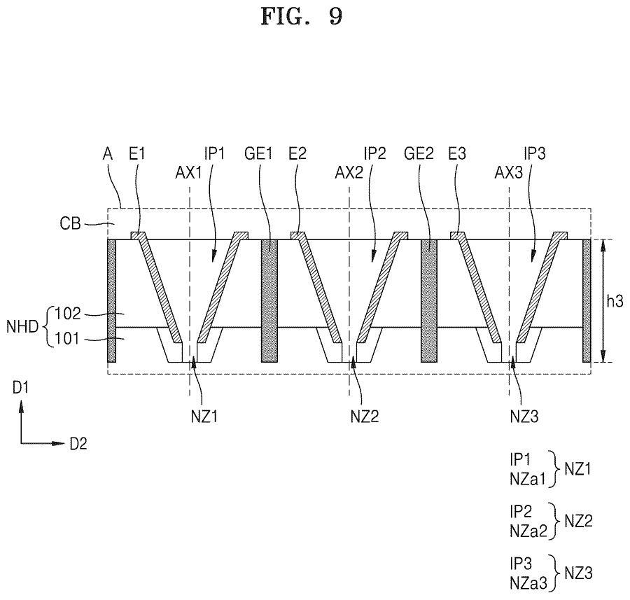

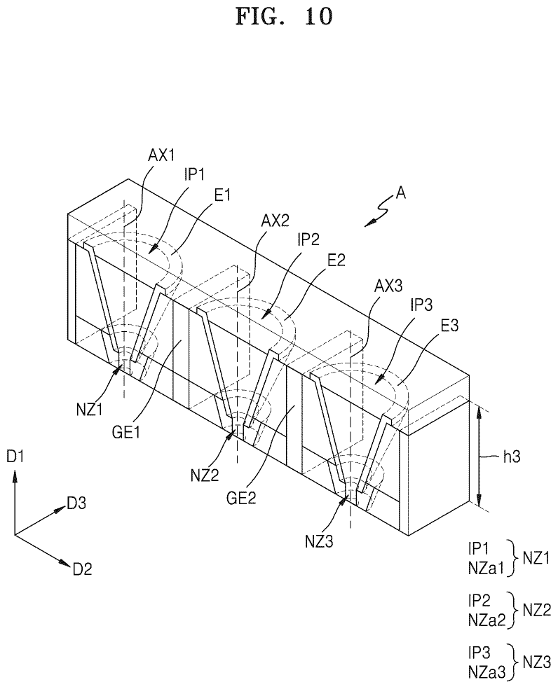

FIG. 9 is a schematic cross-sectional view of a third example of a region A of FIG. 1, and FIG. 10 is a schematic perspective view of the third example of a region A of FIG. 1.

For reference, in the description of FIGS. 9 and 10, contents substantially identical or similar to or repeating those described above may be omitted.

The shielding electrodes may include at least a first shielding electrode GE1, a second shielding electrode GE2, and a third shielding electrode GE3. The shielding electrodes may include an additional shielding electrode GE0. As an example, the shielding electrodes may include a ground electrode. The shielding electrodes may be grounded. As an example, the height of each of the shielding electrodes may be the thickness of the nozzle plate NHD. As an example, the height of each of the shielding electrodes may be a third length h3, and the third length h3 may be the thickness of the nozzle plate NHD. The third length h3 may be greater than the first length h1. The third length h3 may be greater than the second length h2.

As shown in FIGS. 9 and 10, the first shielding electrode GE1 may be arranged between the first nozzle portion NZ1 and the second nozzle portion NZ2. The first shielding electrode GE1 may be included inside the nozzle plate NHD. The first shielding electrode GE1 may be in contact with the bottom surface of the nozzle plate NHD and be in contact with the upper surface of the upper plate 102. Specifically, the first shielding electrode GE1 may extend from the bottom surface of the nozzle plate NHD to the upper surface of the nozzle plate NHD. The first shielding electrode GE1 may extend from the lower plate 101 to the upper surface of the upper plate 102. The first shielding electrode GE1 may be arranged between the first driving electrode E1 and the second driving electrode E2. The first shielding electrode GE1 may be arranged between the first axis AX1 and the second axis AX2.

The second shielding electrode GE2 may be arranged between the second nozzle portion NZ2 and the third nozzle portion NZ3. The second shielding electrode GE2 may be included inside the nozzle plate NHD. The second shielding electrode GE2 may be in contact with the bottom surface of the nozzle plate NHD and be in contact with the upper surface of the upper plate 102. Specifically, the second shielding electrode GE2 may extend from the bottom surface of the nozzle plate NHD to the upper surface of the nozzle plate NHD. The second shielding electrode GE2 may extend from the lower plate 101 to the upper surface of the upper plate 102. The second shielding electrode GE2 may be arranged between the second driving electrode E2 and the third driving electrode E3. The second shielding electrode GE2 may be arranged between the second axis AX2 and the third axis AX3.

The shielding electrodes may further include the third shielding electrode GE3 and the additional shielding electrode GE0 in addition to the first shielding electrode GE1 and the second shielding electrode GE2. The third shielding electrode GE3 and the additional shielding electrode GE0 may also extend from the bottom surface of the nozzle plate NHD to the upper surface of the nozzle plate NHD. The third shielding electrode GE3 and the additional shielding electrode GE0 may also extend from the lower surface of the lower plate 101 to the upper surface of the upper plate 102.

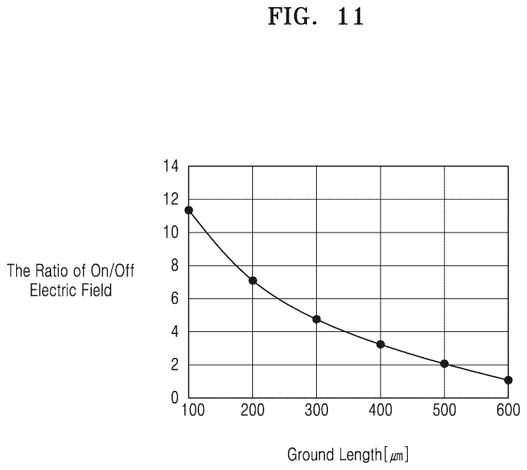

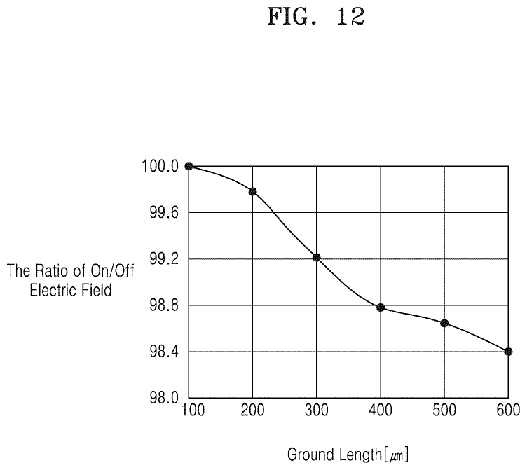

FIGS. 11 and 12 are graphs showing an electric field shielding effect according to a height to each of shielding electrodes.

For reference, in the description of FIGS. 11 and 12, contents substantially identical or similar to or repeating those described above may be omitted.

A ground height of an x axis in FIG. 11 may mean a height of each of the shielding electrodes. A height of each of the shielding electrodes may mean a length in the first direction D1 shown in the above-described drawings. A height of each of the shielding electrodes may mean a length in a thickness direction of the nozzle plate NHD. The y axis in FIG. 11 denotes a ratio of an intensity of an electric field measured by a neighboring nozzle portion adjacent to a nozzle portion that is turned on/off, and specifically, may be a ratio of an intensity of an electric field measured around a neighboring nozzle head adjacent to the nozzle portion that is turned on/off.

As shown in FIG. 11, it may be determined that, as a height of each of the shielding electrodes increases, a ratio of an intensity of an electric field measured around a neighboring nozzle head adjacent to a nozzle portion that is turned on/off, is reduced. For example, it may be determined that, as a ratio of an intensity of an electric field measured around a neighboring nozzle head adjacent to a nozzle portion that is turned on/off, is reduced, a shielding effect increases. Accordingly, for greater shielding effect, a height of each of the shielding electrodes needs to increase.

As shown in FIG. 11, a height of each of the shielding electrodes may be about 600 μm. As an example, the height of each of the shielding electrodes may be substantially equal to the thickness of the nozzle plate NHD as in the third example. The height of each of the shielding electrodes may increase until the height is substantially equal to the thickness of the nozzle plate NHD as in the third example.

Numerical values shown in FIG. 11 are summarized in Table as follows.

TABLE 3

| Ground Height [μm] | On[V/m] | Off[V/m] | Ratio[%] |
|---|---|---|---|
| 100 | 1.045E+07 | 1.2E+06 | 11.6 |
| 200 | 1.043E+07 | 7.3E+05 | 7.0 |
| 300 | 1.037E+07 | 5.0E+05 | 4.8 |
| 400 | 1.033E+07 | 3.3E+05 | 3.2 |
| 500 | 1.031E+07 | 2.1E+05 | 2.0 |
| 600 | 1.029E+07 | 1.2E+05 | 1.2 |

A ground height of an x axis in FIG. 12 may mean a height of each of the shielding electrodes. A height of each of the shielding electrodes may mean a length in the first direction D1 shown in the above-described drawings. A height of each of the shielding electrodes may mean a length in a thickness direction of the nozzle plate NHD. A y axis of FIG. 12 may be a ratio of a reduced amount of an electric field measured by a neighboring nozzle portion adjacent to a nozzle portion that is turned on.

As shown in FIG. 12, it may be determined that, as a height of each of the shielding electrodes increases, a ratio of a reduced amount of an electric field measured by a neighboring nozzle portion adjacent to a nozzle portion that is turned on is reduced. For example, it may be determined that, as a ratio of the amount of an electric field measured by a neighboring nozzle portion adjacent to a nozzle portion that is turned on is reduced, a shielding effect increases. Accordingly, for greater shielding effect, a height of each of the shielding electrodes needs to increase.

As shown in FIG. 12, a height of each of the shielding electrodes may be about 600 μm. As an example, the height of each of the shielding electrodes may be substantially equal to the thickness of the nozzle plate NHD as in the third example. The height of each of the shielding electrodes may increase until the height is substantially equal to the thickness of the nozzle plate NHD as in the third example.

Numerical values shown in FIG. 12 are summarized in Table as follows.

TABLE 4

| Ground Height [μm] | On[V/m] | Ratio[%] |
|---|---|---|
| 100 | 1.045E+07 | 100.0 |
| 200 | 1.043E+07 | 99.8 |
| 300 | 1.037E+07 | 99.2 |
| 400 | 1.033E+07 | 98.8 |
| 500 | 1.031E+07 | 98.6 |
| 600 | 1.029E+07 | 98.4 |

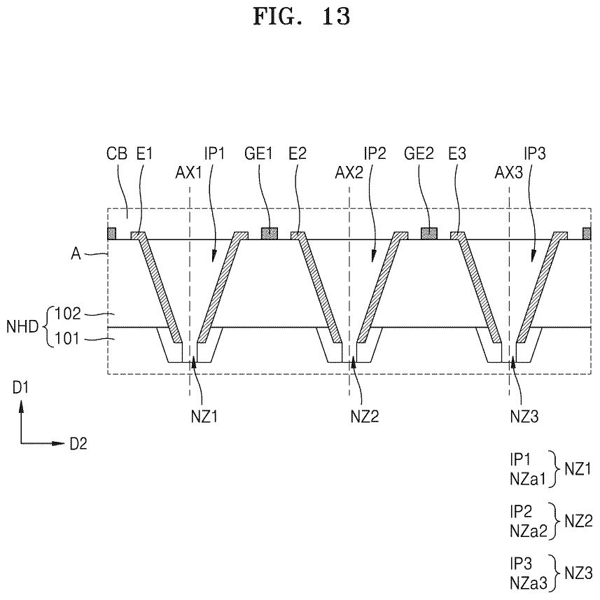

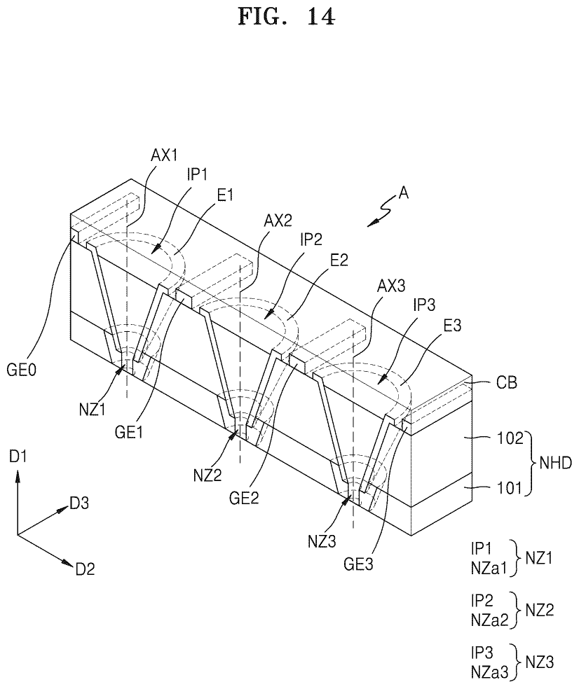

FIG. 13 is a schematic cross-sectional view of a fourth example of the region A of FIG. 1, and FIG. 14 is a schematic perspective view of the fourth example of the region A of FIG. 1.

For reference, in the description of FIGS. 13 and 14, contents substantially identical or similar to or repeating those described above may be omitted.

The shielding electrodes may include at least a first shielding electrode GE1, a second shielding electrode GE2, and a third shielding electrode GE3. The shielding electrodes may include an additional shielding electrode GE0. As an example, the shielding electrodes may include a ground electrode. The shielding electrodes may be grounded.

As an example, each of the shielding electrodes may be disposed on the upper surface of the nozzle plate NHD. The lower surface of each of the shielding electrodes may be in contact with the upper surface of the nozzle plate NHD.

As shown in FIGS. 13 and 14, the first shielding electrode GE1 may be arranged between the first nozzle portion NZ1 and the second nozzle portion NZ2. The first shielding electrode GE1 may be disposed on the upper surface of the nozzle plate NHD. Depending on the case, the first shielding electrode GE1 may be located in the chamber CB. The first shielding electrode GE1 may be in contact with the upper surface of the nozzle plate NHD. The first shielding electrode GE1 may be arranged between the first driving electrode E1 and the second driving electrode E2. The first shielding electrode GE1 may be arranged between the first axis AX1 and the second axis AX2.

The second shielding electrode GE2 may be arranged between the second nozzle portion NZ2 and the third nozzle portion NZ3. The second shielding electrode GE2 may be disposed on the upper surface of the nozzle plate NHD. Depending on the case, the second shielding electrode GE2 may be located in the chamber CB. The second shielding electrode GE2 may be in contact with the upper surface of the nozzle plate NHD. The second shielding electrode GE2 may be arranged between the second driving electrode E2 and the third driving electrode E3. The second shielding electrode GE2 may be arranged between the second axis AX2 and the third axis AX3.

The shielding electrodes may further include the third shielding electrode GE3 and the additional shielding electrode GE0 in addition to the first shielding electrode GE1 and the second shielding electrode GE2. The third shielding electrode GE3 and the additional shielding electrode GE0 may also be disposed on the upper surface of the nozzle.

In the fourth example, voltages inside or around the first nozzle portion NZ1 to the third nozzle portion NZ3 are measured as follows.

TABLE 5

| | First nozzle portion | Second nozzle portion | Third nozzle portion |
|---|---|---|---|
| | (turned-off) | (turned-on) | (turned-off) |
| Measured | About 100 to about 300 | About 1000 to about | About 100 to about 300 |
| voltage (V) | | 1500 | |
| inside nozzle | | | |
| portion | | | |
| Around nozzle | About 0 to about 200 | About 0 to about 1000 | About 0 to about 200 |
| head | | | |
| Measured | | | |
| voltage (V) | | | |

(However, the measured value is not a voltage at a specific point but denotes a voltage distributed in a specific space and is expressed as a numerical range.)

According to Table 5, it may be determined that a magnetic field generated from the second driving electrode E2 has a low influence on the first nozzle portion NZ1 and the third nozzle portion NZ3 due to the first shielding electrode GE1 and the second shielding electrode GE2. The voltage of the inside of the first nozzle portion NZ1 and the third nozzle portion NZ3 is measured to be in a range of about 100 V to about 300 V. This is a numerical value less than a voltage in a range of about 1000 V to about 1500 of the inside of the second nozzle portion NZ2.

The voltage around the first nozzle head NZa1 and the third nozzle head NZa3 is measured to be in a range of about 0 V to about 200 V. This is a measured value relatively less than a voltage of 1000 V or less, which is a voltage around the second nozzle head NZa2, and does not influence inductive electrohydrodynamic driving of the first nozzle portion NZ1 and the third nozzle portion NZ3.

However, it may be determined that measured voltages shown in Table 5 are far less than measured voltages shown in Table 1 and Table 2. Accordingly, the position of the shielding electrode of the fourth example has a greater electric field shielding effect than the position of the shielding electrode of the first example and the second example.

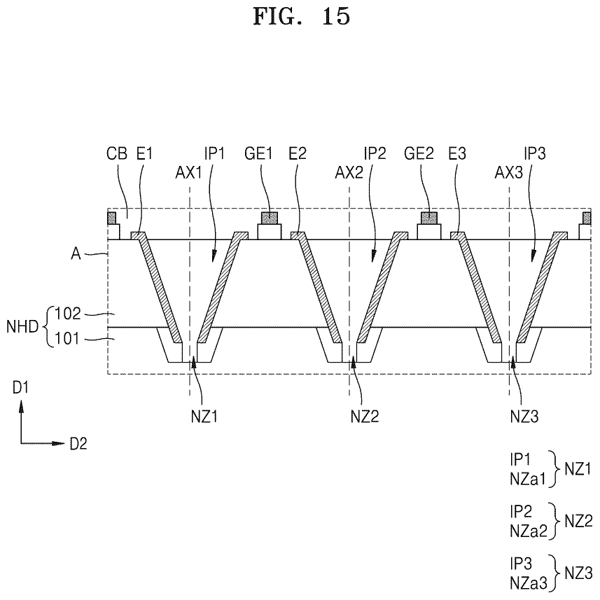

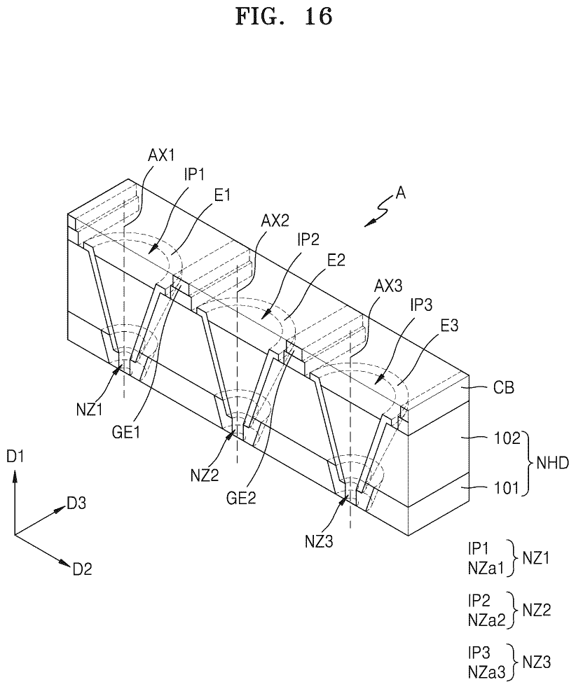

FIG. 15 is a schematic cross-sectional view of a fifth example of the region A of FIG. 1, and FIG. 16 is a schematic perspective view of the fifth example of the region A of FIG. 1.

For reference, in the description of FIGS. 15 and 16, contents substantially identical or similar to or repeating those described above may be omitted.

As shown in FIGS. 15 and 16, partition walls may be arranged between the shielding electrodes and the nozzle plate NHD. As an example, the inkjet printing head 100 of the fifth example may further include the partition walls arranged between the shielding electrodes and the nozzle plate NHD.

The partition walls may include at least a first partition wall and a third partition wall. The partition walls may further include an additional partition wall. As an example, the partition walls may be disposed on the upper surface of the nozzle plate NHD.

The shielding electrodes may include at least a first shielding electrode GE1, a second shielding electrode GE2, and a third shielding electrode GE3. The shielding electrodes may include an additional shielding electrode GE0. As an example, the shielding electrodes may include a ground electrode. The shielding electrodes may be grounded.

As an example, the first partition wall may be arranged between the first nozzle portion NZ1 and the second nozzle portion NZ2. The first partition wall may be arranged between the first driving electrode E1 and the second driving electrode E2. The first partition wall may be arranged between the first axis AX1 and the second axis AX2. As an example, the first shielding electrode GE1 may be disposed on the first partition wall.

As an example, the second partition wall may be arranged between the second nozzle portion NZ2 and the third nozzle portion NZ3. The second partition wall may be arranged between the second driving electrode E2 and the third driving electrode E3. The second partition wall may be arranged between the second axis AX2 and the third axis AX3. As an example, the second shielding electrode GE2 may be disposed on the second partition wall.

In the fifth example, voltages inside or around the first nozzle portion NZ1 to the third nozzle portion NZ3 are measured as follows.

TABLE 6

| | First nozzle portion | Second nozzle portion | Third nozzle portion |
|---|---|---|---|
| | (turned-off) | (turned-on) | (turned-off) |
| Measured | About 100 to about 300 | About 1000 to about | About 100 to about 300 |
| voltage (V) | | 1500 | |
| inside nozzle | | | |
| portion | | | |
| Around nozzle | About 0 to about 200 | About 0 to about 1000 | About 0 to about 200 |
| head | | | |
| Measured | | | |
| voltage (V) | | | |

(However, the measured value is not a voltage at a specific point but denotes a voltage distributed in a specific space and is expressed as a numerical range.)

According to Table 6, it may be determined that a magnetic field generated from the second driving electrode E2 has a low influence on the first nozzle portion NZ1 and the third nozzle portion NZ3 due to the first shielding electrode GE1 and the second shielding electrode GE2. The voltage of the inside of the first nozzle portion NZ1 and the third nozzle portion NZ3 is measured to be in a range of about 100 V to about 300 V. This is a numerical value less than a voltage in a range of about 1000 V to about 1500 of the inside of the second nozzle portion NZ2.

The voltage around the first nozzle head NZa1 and the third nozzle head NZa3 is measured to be in a range of about 0 V to about 200 V. This is a measured value relatively less than a voltage of 1000 V or less, which is a voltage around the second nozzle head NZa2, and does not influence inductive electrohydrodynamic driving of the first nozzle portion NZ1 and the third nozzle portion NZ3.

However, it may be determined that measured voltages shown in Table 6 are far less than measured voltages shown in Table 1 and Table 2. Accordingly, the position of the shielding electrode of the fifth example has a greater electric field shielding effect than the position of the shielding electrode of the first example and the second example.

It may be determined that measured voltages shown in Table 6 are similar to measured voltages shown in Table 5. Accordingly, the position of the shielding electrode of the sixth example has an almost similar electric field shielding effect to the position of the shielding electrode of the fifth example.

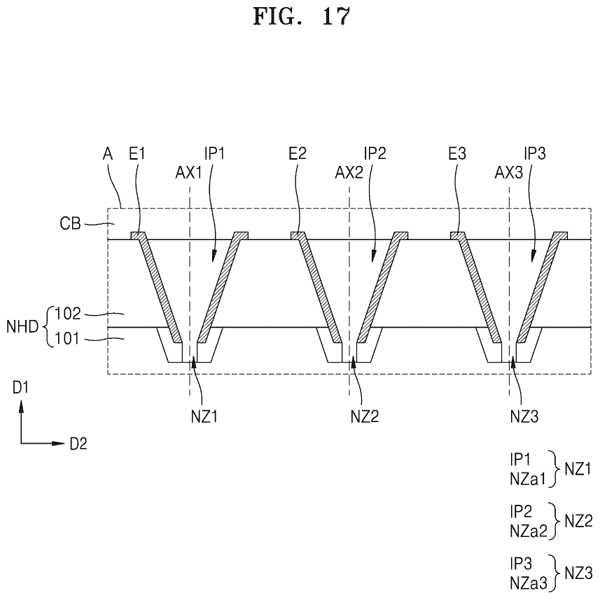

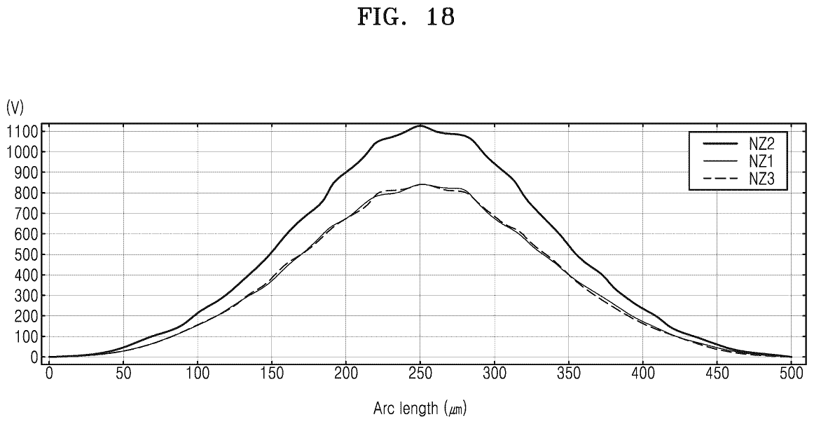

FIG. 17 is a schematic cross-sectional view of a comparative example of the region A of FIG. 1, and FIG. 18 is a graph showing a voltage measured around the first nozzle head NZa1 to the third nozzle head NZa3 of the comparative example.

For reference, in the description of FIGS. 17 and 18, contents substantially identical or similar to or repeating those described above may be omitted.

As shown in FIG. 17, the shielding electrodes may be omitted. Furthermore, the partition walls may be omitted.

Referring to FIG. 18, the voltage around the first nozzle head NZa1 and the third nozzle head NZa3 is measured to be in a range of about 0 V to about 850 V. This is a measured value a slightly less than a voltage of 1100 V or less, which is a voltage around the second nozzle head NZa2, and affects the inductive electrohydrodynamic driving of the first nozzle portion NZ1 and the third nozzle portion NZ3 and there is high possibility that errors will occur in the printing process.

In the comparative example, voltages inside or around the first nozzle portion NZ1 to the third nozzle portion NZ3 are measured as follows.

TABLE 7

| | First nozzle portion | Second nozzle portion | Third nozzle portion |
|---|---|---|---|
| | (turned-off) | (turned-on) | (turned-off) |
| Measured | About 1000 to about | About 1000 to about | About 1000 to about |
| voltage (V) | 1200 | 1500 | 1200 |
| inside nozzle | | | |
| portion | | | |
| Around nozzle | About 0 to about 800 | About 0 to about 1000 | About 0 to about 800 |
| head | | | |
| Measured | | | |
| voltage (V) | | | |

(However, the measured value is not a voltage at a specific point but denotes a voltage distributed in a specific space and is expressed as a numerical range.)

According to Table 7, it may be determined that a magnetic field generated from the second driving electrode E2 has a high influence on the first nozzle portion NZ1 and the third nozzle portion NZ3 due to the first shielding electrode GE1 and the second shielding electrode GE2. The voltage of the inside of the first nozzle portion NZ1 and the third nozzle portion NZ3 is measured to be in a range of about 1000 V to about 1200 V. This is a numerical value similar to the voltage in a range of about 1000 V and about 1500 V of the inside of the second nozzle portion NZ2. It may be determined that the inside of the first nozzle portion NZ1 and the third nozzle portion NZ3 is greatly influenced by the voltage applied to the second nozzle portion NZ2.

The voltage around the first nozzle head NZa1 and the third nozzle head NZa3 is measured to be in a range of about 0 V to about 800 V. This is a measured value relatively similar to a voltage of about 1000 V or less, which is a voltage around the second nozzle head NZa2, and is expected to have a great influence on inductive electrohydrodynamic driving of the first nozzle portion NZ1 and the third nozzle portion NZ3.

It may be determined that the measured voltages shown in Table 7 are far greater than the measured voltages shown in Table 2, Table 5, and Table 6. Accordingly, as in the first example to the sixth example, the inkjet printing head 100 including the shielding electrodes has a greater electric field shielding effect than the inkjet printing head 100 according to the comparative example.

According to an embodiment having the above construction, the inkjet printing head configured to prevent a malfunction of nozzles caused by an electric field generated between the driving electrodes may be implemented. However, the scope of the disclosure is not limited by this effect.

The above description is an example of technical features of the disclosure, and those skilled in the art to which the disclosure pertains will be able to make various modifications and variations. Thus, the embodiments of the disclosure described above may be implemented separately or in combination with each other.

The embodiments disclosed in the disclosure are intended not to limit the technical spirit of the disclosure but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An inkjet printing head comprising:
a chamber storing ink;
a nozzle plate disposed under the chamber, connected to an inside of the chamber, and including a plurality of nozzles that discharge the ink to outside through a bottom surface of the chamber;
a plurality of driving electrodes each disposed to be adjacent to the plurality of nozzles, respectively, inside the nozzle plate; and
a plurality of shielding electrodes disposed inside the nozzle plate,
wherein each of the plurality of shielding electrodes is disposed between the plurality of nozzles.

2. The inkjet printing head of claim 1, wherein the plurality of shielding electrodes are grounded.

3. The inkjet printing head of claim 1, wherein the plurality of driving electrodes are in direct contact with the ink.

4. The inkjet printing head of claim 1, further comprising:
a voltage supply portion that applies a voltage to the plurality of driving electrodes.

5. The inkjet printing head of claim 1, wherein the plurality of driving electrodes are disposed along an inner lateral surface of the plurality of nozzles.

6. The inkjet printing head of claim 1, wherein the plurality of shielding electrodes are arranged between the plurality of driving electrodes.

7. The inkjet printing head of claim 1, wherein an upper surface of each of the plurality of shielding electrodes is apart from an upper surface of the nozzle plate by a first length.

8. The inkjet printing head of claim 1, wherein the nozzle plate includes:
a lower plate including a plurality of nozzle heads that discharge the ink to outside through a bottom surface of the chamber; and
an upper plate including an ink transfer passage that transfers the ink from the chamber to the plurality of nozzle heads.

9. The inkjet printing head of claim 8, wherein a lower surface of each of the plurality of shielding electrodes is in contact with an upper surface of the lower plate.

10. The inkjet printing head of claim 9, wherein an upper surface of each of the plurality of shielding electrodes is apart from an upper surface of the upper plate by a second length.

11. The inkjet printing head of claim 1, wherein a height of each of the plurality of shielding electrodes is substantially equal to a height of the nozzle plate.

12. The inkjet printing head of claim 1, wherein each of the plurality of shielding electrodes is disposed between a lower surface of the nozzle plate and an upper surface of the nozzle plate.

13. An inkjet printing head comprising:
a chamber storing ink;
a nozzle plate disposed under the chamber, connected to an inside of the chamber, and including a plurality of nozzles that discharge the ink to outside through a bottom surface of the chamber;
a plurality of driving electrodes each disposed to be adjacent to the plurality of nozzles, respectively, inside the nozzle plate; and
a plurality of shielding electrodes disposed on an upper surface of the nozzle plate,
wherein each of the plurality of shielding electrodes is disposed between the plurality of nozzles.

14. The inkjet printing head of claim 13, wherein the plurality of shielding electrodes are grounded.

15. The inkjet printing head of claim 13, wherein the plurality of driving electrodes are in direct contact with the ink.

16. The inkjet printing head of claim 13, further comprising:
a voltage supply portion that applies a voltage to the plurality of driving electrodes.

17. The inkjet printing head of claim 13, wherein the plurality of driving electrodes are disposed along an inner lateral surface of the plurality of nozzles.

18. The inkjet printing head of claim 13, wherein the plurality of shielding electrodes are arranged between the plurality of driving electrodes.

19. The inkjet printing head of claim 13, wherein the nozzle plate includes:
a lower plate including a plurality of nozzle heads that discharge the ink to outside through a bottom surface of the chamber; and
an upper plate including an ink transfer passage that transfers the ink from the chamber to the plurality of nozzle heads.

20. The inkjet printing head of claim 13, further comprising:
a plurality of partition walls disposed between the plurality of shielding electrodes and the nozzle plate.
